(19) United States
(12) Patent Application Publication
(10) Pub. No.: US 2016/0146960 A1
(43) Pub. Date: May 26, 2016

(54) METHOD OF ANALYSING A SUBSURFACE REGION

(71) Applicant: SCHLUMBERGER TECHNOLOGY CORPORATION, Sugar Land, TX (US)

(72) Inventors: Dirk Gunnar Steckhan, Stavanger (NO); Oddgeir Gramstad, Stavanger (NO); Michael Nickel, Stavanger (NO); Lars Sonneland, Stavanger (NO)

(21) Appl. No.: 14/549,672

(22) Filed: Nov. 21, 2014

(51) Int. Cl. G01V 1/30; G01V 1/40

(52) U.S. Cl. CPC G01V 1/306; G01V 1/308; G01V 1/303; G01V 1/40; G01V 2210/62

(57) ABSTRACT

A method of analysing a subsurface region. 4D seismic data is received from a subterranean reservoir that is being seismically evaluated. A first set of values representing a first attribute at a plurality of first coordinates within the subsurface region is obtained from the 4D seismic data. A second set of values representing a second attribute at a plurality of second coordinates within the subsurface region is also obtained from the 4D seismic data, wherein each of the plurality of second coordinates corresponds to a respective first coordinate. For each first coordinate, a measure of dependence is calculated and the calculated measure of dependence is used to detect changes in the reservoir over time.

This disclosure relates to a method of analysing a subsurface region. The characterisation of subsurface strata is important for identifying, accessing and managing a subsurface reservoir (e.g. a reservoir of oil and/or gas). The depths and orientations of such strata can be determined, for example, by using a seismic technique, such as seismic surveying. This is generally performed by imparting energy to the earth at one or more source locations, for example, by way of controlled explosion, mechanical input etc. Return energy is then measured at one or more surface receiver locations, typically at varying distances and azimuths from the one or more source locations. The travel-time and/or amplitude of energy from source(s) to receiver(s), via reflections and refractions from interfaces of subsurface strata, can be used to indicate the depth and orientation of the strata.

Seismic techniques are sometimes referred to simply by the term “seismic”. Subsurface reservoirs (e.g. of oil and/or gas) can change subtly over time, e.g. due to injection into the reservoir, i.e. water injection and/or production of fluids from the reservoir. For example, oil filled sandstone can gradually change to water filled sandstone. Such changes can be measured via subtle changes in acoustic velocity.

“Time lapse seismic” can be used to detect changes in a subsurface reservoir over time. Time lapse seismic may be performed by conducting two seismic surveys of the same subsurface region at different times, to obtain two sets of seismic data obtained at different times. In this case, the two sets of seismic data may be referred to as “time lapse seismic data”.

“Time lapse seismic” can be referred to as “4D seismic” if two 3D seismic surveys used are conducted at different times, to obtain two sets of 3D seismic data obtained at different times (since time can be viewed as providing a fourth dimension to this data). In this case, the two sets of 3D seismic data may be referred to as “4D seismic data” or “time lapse cubes”.

4D seismic is typically used to monitor how reservoir dynamics behave while injection and/or production is performed. This monitoring can help in maximizing production, ensuring reservoir integrity and/or avoiding drilling hazards.

4D seismic may provide information about the dynamic behavior of a subsurface region between two seismic surveys. Such information may include density changes, elastic wave velocity changes, and displacement of seismic events (displacement of events may be mostly due to velocity changes and in a smaller degree due to mechanical displacement). “Inversion”, using a rock model, may be used to relate the time-lapse changes to changes in rock properties, pressure, temperature, saturation and rock displacements.

Within the field of 4D seismics, a metric may be used to visualize differences between two time lapse cubes. Metrics previously considered to visualize differences between one time lapse cube and another in 4D seismic include: plain difference (subtraction of corresponding values), L1 norm (taking the modulus of the result obtained by subtracting corresponding values—this techniques is sometimes written as “I1 norm”), and normalized root mean square [1].

In order to produce a useful visualization, the two separate 3D surveys used to obtain 4D seismic data should be performed with conditions as close as possible to each other. This is difficult in practice, not least because the two 3D surveys may be performed with a large time gap between them (e.g. a year). Even small differences in the conditions under which two 3D surveys are performed can create a significant amount of noise when using existing metrics to visualize changes in the 4D seismic data.

### SUMMARY

Embodiments of the present disclosure have been devised in light of the above considerations.

By way of summary, in one embodiment of the present disclosure 4D seismic data is received from a subterranean reservoir that is being seismically evaluated. A first set of values representing a first attribute at a plurality of first coordinates within the subsurface region is obtained from the 4D seismic data. A second set of values representing a second attribute at a plurality of second coordinates within the subsurface region is also obtained from the 4D seismic data, wherein each of the plurality of second coordinates corresponds to a respective first coordinate. For each first coordinate, a measure of dependence is calculated—wherein the calculated measure of dependence may comprise a probability dependence of the first and the second set of values—by:
identifying a subset of the first coordinates that lie in a neighbourhood around the first coordinate;
extracting, from the set of first values, the first values that represent the first attribute at the subset of the first coordinates;
extracting, from the set of second values, the second values that represent the second attribute at a subset of the second coordinates, wherein the second coordinates in the subset of the second coordinates correspond to the first coordinates in the subset of first coordinates; and
calculating a measure of dependence representative of the dependence of the extracted first values on the extracted second values, wherein the measure of dependence is configured for measuring a non-linear dependence of the extracted first values on the extracted second values.

The calculated measure of dependence is used to detect changes in the reservoir over time.

In some embodiments, the detected changes in the reservoir over time comprise classifying top and base surfaces of the reservoir. In some embodiments the detected changes in the reservoir over time comprise identifying change versus non-change neighborhoods in the reservoir.

In some embodiments, the 4D seismic data is recorded while fluids are being injected into the reservoir and/or hydrocarbons are being produced from the reservoir. In some embodiments, the detected changes in the reservoir over time are used to extract faults and/or salt bodies from the 4D seismic data.

A first aspect of an embodiment of the present disclosure may provide a method of analysing a subsurface region, the method including:
obtaining a set of first values that represent a first attribute at a plurality of first coordinates within the subsurface region;
obtaining a set of second values that represent a second attribute at a plurality of second coordinates within the subsurface region, wherein each second coordinate corresponds to a respective first coordinate;
for each first coordinate, calculating a measure of dependence by:
identifying a subset of the first coordinates that lie in a neighbourhood around the first coordinate;
extracting, from the set of first values, the first values that represent the first attribute at the subset of the first coordinates;
extracting, from the set of second values, the second values that represent the second attribute at a subset of the second coordinates, wherein the second coordinates in the subset of the second coordinates correspond to the first coordinates in the subset of first coordinates;
calculating a measure of dependence representative of the dependence of the extracted first values on the extracted second values, wherein the measure of dependence is capable of measuring a non-linear dependence of the extracted first values on the extracted second values.

The measures of dependence calculated according to this method can be used to provide a robust (e.g. with higher signal to noise ratio) indication of differences between the first set of values and the second set of values, which can be used to analyse the subsurface region.

Additionally, the measure of dependence is capable of measuring a non-linear dependence of the extracted first values on the extracted second values such that the method can be used to analyse the relationship between different attributes within the subsurface region.

Example measures of dependence that are capable of measuring a non-linear dependence of the extracted first values on the extracted second values are: variation of information, mutual information and distance correlation, since all of these measures of dependence are capable of measuring a non-linear dependence of a first variable on a second variable.

Some of these measures of dependence are discussed in the “theoretical background” sections, below.

However, it is to be noted that not all measures of dependence are capable of measuring a non-linear dependence of a first variable on a second variable. For example, normalised root mean square (“NMRS”) is not capable of measuring anon-linear dependence.

A normalized measure of dependence, such as normalized variation of information (“NVI”), that returns a value between two predetermined values (e.g. between 0 and 1, as is the case for NVI) may be used as the measure of dependence since such a measure provides that measures of dependence can be meaningfully compared with each other.

In some embodiments, variation of Information, more preferably normalized variation of information (“NVI”), is used as the measure of dependence.

However, other measures of dependence could equally be used as the measure of dependence, provided that the measure of dependence is capable of measuring a non-linear dependence of a first variable on a second variable. Mutual information and distance correlation are examples of other possible measures of dependence.

In some embodiments, each second coordinate may correspond substantially to (i.e. be substantially the same as) a respective first coordinate. In this case, the method could be rewritten as:
obtaining a set of first values that represent a first attribute at a plurality of coordinates within a subsurface region;
obtaining a set of second values that represent a second attribute at the plurality of coordinates within the subsurface region;
for each coordinate, calculating a measure of dependence by:
   identifying a subset of the coordinates that lie in a neighbourhood around the coordinate;
   extracting, from the set of first values, the first values that represent the first attribute at the subset of the coordinates;
   extracting, from the set of second values, the second values that represent the second attribute at the subset of the coordinates;
   calculating a measure of dependence representative of the dependence of the extracted first values on the extracted second values, wherein the measure of dependence is capable of measuring a non-linear dependence of the extracted first values on the extracted second values.

However, a skilled person will appreciate that it is not a requirement that each second coordinate is the same as a respective first coordinate.

For example, the set of first values and the set of second values could be obtained under different conditions or at different times, which could result in there being subtle differences between the first coordinates and the second coordinates. In some embodiments, a technique such as “non-rigid matching” or linear regression (e.g. “least squares”) analysis could be used to pre-align the set of first values and the set of second values after these values have been obtained. Such techniques could also be used to eliminate any linear dependence between the set of first values and the set of second values, e.g. such that the method could be used to assess any non-linear dependence between the set of first values and the set of second values.

As another example, the set of first values may represent a first attribute at a plurality of first coordinates within a first subregion of the subsurface region, with the set of second values representing a second attribute at a plurality of second coordinates within a second subregion of the subsurface region.

Nonetheless, in some embodiments, each second coordinate may correspond substantially to (i.e. be substantially the same as) a respective first coordinate.

Whilst it is not a requirement that each second coordinate is substantially the same as a respective first coordinate (see above), there is preferably a one-to-one correspondence between the first coordinates and the second coordinate, i.e. such that every first coordinate is paired with a respective second coordinate. In other words, the plurality of first coordinates and the plurality of second coordinates are preferably bijective. This could also be expressed by saying that each second coordinate preferably bijectively corresponds to a respective first coordinate.

The method may include plotting each measure of dependence using the first coordinate for which the measure of dependence was calculated, and/or using the second coordinate corresponding to the first coordinate for which the measure of dependence was calculated. In this way, the measures of dependence can be provided in visual form, e.g. which may allow differences between the set of first values and the set of second values to be identified.

Nonetheless, instead of plotting each measure of dependence, the method may include recording each measure of dependence using the first coordinate for which the measure of dependence was calculated, and/or using the second coordinate corresponding to the first coordinate for which the measure of dependence was calculated. Recording the measures of dependence in this way could be done e.g. for subsequent analysis of the measures of dependence by a computer.

Calculating a measure of dependence representative of the dependence of the extracted first values on the extracted second values (for each first coordinate) may include:
producing 2D frequency/probability data that represents the frequency/probability at which combinations of first and second values occur (for first and second values having corresponding first and second coordinates) within the extracted first and second values; and
calculating a measure of dependence representative of the dependence of the extracted first values on the extracted second values from the 2D frequency/probability data.

The 2D frequency/probability data may be discrete, in which case calculating a measure of dependence representative of the dependence of the extracted first values on the extracted second values (for each first coordinate) may include:
discretizing the extracted first values and the extracted second values;
producing discrete 2D frequency/probability data that represents the frequency/probability at which combinations of discretized first and second values occur (for first and second values having corresponding first and second coordinates) within the extracted first and second values; and
calculating a measure of dependence representative of the dependence of the extracted first values on the extracted second values from the discrete 2D frequency/probability data.

If the 2D frequency/probability data is discrete, discretizing the extracted first values and the extracted second values may be performed by binning the extracted first values and the extracted second values, that is by putting the extracted first values in a plurality of first data bins (each first data bin describing a respective range of first values), and by putting the extracted second values in a plurality of second data bins (each second data bin describing a respective range of second values).

The binning of the extracted first values and the binning of the extracted second values may be performed independently of one another.

Binning of the extracted first values and the extracted second values may be performed according to a known binning technique, and preferably according to an adaptive binning technique, e.g. as taught by Scott [2]. Binning techniques are well known.

Whilst the 2D frequency/probability data may be discrete (as described above), it is also be possible to produce continuous 2D frequency/probability data, e.g. by estimating a function that describes the relationship between extracted first values and the extracted second values.

The first values may represent a first attribute at the plurality of first coordinates within the subsurface region at a first time, with the second values representing the second attribute at the plurality of second coordinates within the subsurface region at a second time.

For the avoidance of any doubt, the first attribute may be the same as the second attribute, and the first time may be the same as the second time. However, if the first attribute is the same as the second attribute, then the first time should be different to the second time (to avoid the first and second values being the same). Likewise, if the first time is the same as the second time, then the first attribute should be different to the second attribute (to avoid the first and second values being the same).

In some embodiments, the first attribute is the same as the second attribute, and the first time is different to the second time. In this case, provided the plurality of first coordinated are substantially the same as the plurality of second coordinates, the measures of dependence calculated according to the method described above can be used to show how the attribute changes between the first time and the second time within the subsurface region, e.g. as might be useful for time lapse seismic data.

However, in other embodiments, the first attribute may be different from the second attribute (regardless of whether the first time is the same as the second time or not). In this case, provided the plurality of first coordinates are substantially the same as the plurality of second coordinates, the measures of dependence calculated according to the method described above can be used to show a relationship (e.g. dependence) between the first attribute and the second attribute within the subsurface region. This could be helpful to detect features that are common to both attributes.

The set of first values may represent a first seismic attribute at a plurality of coordinates within the subsurface region, in which case the set of first values may be referred to as first seismic data.

Similarly, the set of second values may represent a second seismic attribute at a plurality of coordinates within the subsurface region (the second seismic attribute may be the same as or different to the first seismic attribute), in which case the set of second values may be referred to as second seismic data.

Herein, values representing a seismic attribute can be understood as any values obtained (directly or indirectly) using a seismic technique.

Using a seismic technique may include, for example, imparting energy to earth at one or more source locations, and measuring return energy at one or more receiver locations. However, a seismic technique need not include imparting energy to earth, e.g. since passive seismic (or “microseismic”) techniques are known in which energy from earth is measured at one or more receiver locations without necessarily imparting energy to the earth.

Example seismic attributes include amplitude, frequency, attenuation, two way travel time (“TWT”), instantaneous frequency and phase, bandwidth, envelope, magnitude, variance, reflection intensity, sweetness, derivative attributes, texture attributes, chaos.

Texture Attributes may be a set of metrics that quantify the perceived texture of an image/volume. They can give information about the spatial arrangement of intensities.

Derivative attributes may be used to approximate the local (nth-order) derivative of a volume in x, y and z direction. Using such a filter can enhance edges in images/volumes. Calculating the gradient magnitude or applying a Sobel or Laplacian filter would be a classic example of derivative based image processing.

Chaos may be a measure that distinguishes stratified regions from non-stratified (chaotic) regions. The calculation may be based on confidence of a Dip and Azimuth estimate. In short, it may involve calculating the local gradient vector, constructing a local covariance matrix and doing a PCA on that matrix. The smallest resulting Eigenvalue may give an estimate of the confidence of the Azimuth/Dip calculation and thus how unstratified/chaotic a region is, see e.g. [3].

For the avoidance of any doubt, values that represent a seismic attribute could be measured directly using a seismic technique (e.g. amplitude) or could be derived indirectly from values obtained using a seismic technique (e.g. bandwidth).

Note that if the set of first values represent a seismic attribute at a plurality of coordinates within an subsurface region at a first time, with the set of second values representing the same seismic attribute at substantially the same plurality of coordinates within the subsurface region at a second time (the second time being different to the first time), then the first and second sets of values can together be viewed as forming time lapse seismic data, in which case the measures of dependence calculated according to the method described above may be used to show how the seismic attribute changes between the first time and the second time. Indeed, if the plurality of first coordinates and the plurality of second coordinates are spatially distributed in three spatial dimensions (i.e. such the first and second sets of values can be viewed as 3D seismic data), then the first and second sets of values can together be viewed as forming 4D seismic data.

Also note that it is possible for the set of first values to represent a first seismic attribute at a plurality of coordinates within the subsurface region, with the set of second values representing a second seismic attribute at substantially the same coordinates within the region (the first seismic attribute being different to the second seismic attribute). In this case, the measures of dependence calculated according to the method described above can be used to show a relationship (e.g. dependence) between the first seismic attribute and the second seismic attribute. This could be helpful to detect features that are common to both seismic attributes.

Although the first and second sets of values may represent seismic attributes, this is not necessarily the case. As is known by a skilled person, values representative of an attribute at a plurality of coordinates within a subsurface region can be obtained through a variety of different (non-seismic) techniques, e.g. by measuring reflection/refraction of electromagnetic radiation (e.g. ground penetrating radar measurements), by measuring radioactive particles hitting a counter (e.g. measurement of natural emission of gamma ray radiation from sediments, e.g. using a Geiger-Muller counter), by measuring electric resistivity, by measuring sound (e.g. ultrasound velocity), by gravitational measurements, by magnetic measurements. Therefore, the first and second sets of values may in some embodiments represent non-seismic attributes.

The plurality of first coordinates and the plurality of second coordinates may be distributed in one, two or three spatial dimensions, in which case the first and second sets of values may be viewed as 1D, 2D or 3D data.

If the coordinates are distributed in three spatial dimensions, the value at each coordinate may be referred to as a “voxel”.

If the plurality of first coordinates and the plurality of second coordinates are distributed in one spatial dimension, the first set of values could represent well log data values (e.g. measurements of some seismic or non-seismic attribute taken in one direction from a location in a bore hole) at a first time, with the second set of values representing the well log data values at a second time different to the first time.

The subsurface region may be a subsurface reservoir (e.g. of oil and/or gas).

A second aspect of an embodiment of the present disclosure may provide a computer-readable medium having computer-executable instructions configured to cause a computer to perform a method according to the first aspect of an embodiment of the present disclosure.

A third aspect of an embodiment of the present disclosure may provide an apparatus configured to perform a method according to the first aspect of an embodiment of the present disclosure.

Embodiments of the present disclosure also includes any combination of the aspects and features described except where such a combination is clearly impermissible or expressly avoided.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 shows a method of analysing a subsurface region using time lapse seismic data.

FIG. 2A shows amplitude values for two orthogonal vertical cross sections through the subsurface reservoir as viewed from a perspective angle.

FIG. 2B shows amplitude values for the same two orthogonal vertical cross sections through the same subsurface reservoir as viewed from the same perspective angle 12 months later.

FIG. 3A shows amplitude values for the top surface of the subsurface reservoir shown in FIG. 2A.

FIG. 3B shows amplitude values for the top surface of the same subsurface reservoir area 12 months later.

FIG. 4A shows the result of applying using example workflow 1 to visualize the time lapse cubes shown in FIG. 2A and FIG. 2B.

FIG. 4B shows the result of using conventional L1 norm to visualize the time cubes shown in FIG. 2A and FIG. 2B.

FIG. 5 shows a visualization of different measures and their relations for a set of dependent random variables.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The following discussion describes examples of our proposals that, in some embodiments, involve a method in which a metric is used to visualize/detect changes in time-lapse seismic data. A possible application of this method is, for example, the classification of top and base surfaces of a subsurface reservoir.

However, the method is not limited to time-lapse cubes, it can also be used to visualize/determine/classify dependences of different attributes on each other (e.g. determine how related one attribute is to another, without necessarily involving any time lapse). The method can also be used to analyse geological objects such as surfaces, faults, geobodies and point sets.

In some embodiments, the method can be used to help in the detection of changes in 4D seismic data. In some embodiments, the method uses a metric that may be based on the concepts of “mutual information” and “variation of information”. These concepts were first introduced by Shannon [4] with respect to information theory. Both metrics provide a distance measure of the probability dependence of two random variable distributions. Hence, these are non-linear metrics capable of measuring a non-linear dependence of a first variable on a second variable.

In some embodiments, for each coordinate in a first cube, the values (i.e. that represent an attribute at a given coordinate) in a defined neighbourhood around that coordinate are extracted. Each coordinate in the first cube preferably bijectively corresponds to a respective coordinate in a second cube. The distribution of the values in the neighbourhood is adaptively discretized and thus a 2D frequency/probability density function for the discretized values may be derived. By applying a metric to the 2D frequency/probability density function, a measure of dependence (e.g. “shared information”) can be extracted for each point. This measure may be non-linear and can provide a robust indication of change versus non-change neighbourhoods.

The method may be used for time-lapse geological objects but can also be employed for any type of attribute. Other possible uses are the extraction of faults and salt as well as the comparison of attributes.

### Method of Analysing a Subsurface Region Using Time Lapse Seismic Data

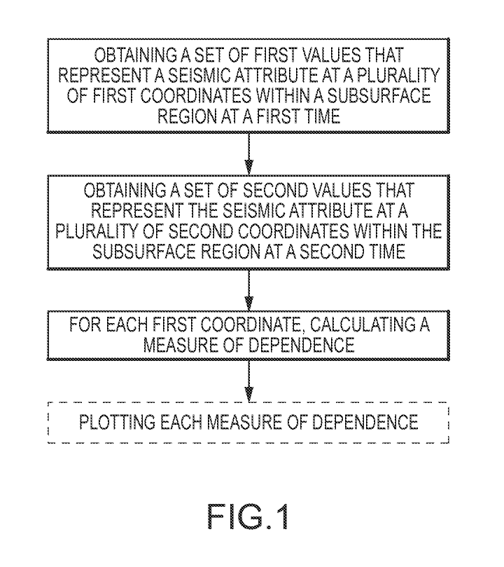

FIG. 1 shows a method of analysing a subsurface region using time lapse seismic data.

As shown in FIG. 1, the method may include:
obtaining a set of first values that represent a seismic attribute at a plurality of first coordinates within a subsurface region (e.g. a subsurface reservoir) at a first time;
obtaining a set of second values that represent the seismic attribute at a plurality of second coordinates within the subsurface region at a second time (wherein each second coordinate corresponds to a respective first coordinate, and wherein the first time is different to the second time);
for each first coordinate, calculating a measure of dependence.

Note that the first set of values can be viewed as first seismic data, the second set of values can be viewed as second seismic data, and the first and second sets of values can together be viewed as time lapse seismic data.

In the case of 4D seismic data, the set of first values and the set of second values will generally be obtained at different times, which could result in there being subtle differences between the first coordinates and the second coordinates. In some embodiments, a technique such as “non-rigid matching” or linear regression (e.g. “least squares”) analysis may be used to pre-align the set of first values and the set of second values, such that each second coordinate is substantially the same as a respective first coordinate. Such techniques could also be used to eliminate any linear dependence between the set of first values and the set of second values, e.g. such that the method could be used to assess any non-linear dependence between the set of first values and the set of second values.

By way of example, non-rigid matching may involve registering the first and second coordinates in such a way that the linear dependence is maximized between the two seismic surveys (“seismic A”, “seismic B”) that provided the sets of first and second values. This may involve seismic A and seismic B being registered in a local area such that A=BX+ε, where X is a local linear transform and ε is the error that was minimized by the linear transform X. This error ε could then be viewed as including two components: (i) a noise component; and (ii) a component that describes the non-linear dependence between both surveys.

However, any linear regression analysis (e.g. “least squares” analysis) could potentially be used to estimate X.

Note that the method as shown in FIG. 1 would not automatically distinguish between linear and non-linear dependence. However by first minimizing the linear error and then comparing the error ε to Seismic B, a non-linear relationship could be identified using the method shown in FIG. 1, provided that the measure of dependence is capable of measuring a non-linear dependence of the extracted first values on the extracted second values.

Moreover, if the first and second coordinates are distributed in three dimensions, then the first and second sets of values can together be viewed as 4D seismic data.

Calculating a measure of dependence for each first coordinate includes, for each first coordinate:
identifying a subset of the first coordinates that lie in a neighbourhood around the first coordinate;
extracting, from the set of first values, the first values that represent the first seismic attribute at the subset of the first coordinates;
extracting, from the set of second values, the second values that represent the seismic attribute at a subset of the second coordinates, wherein the second coordinates in the subset of the second coordinates correspond to the first coordinates in the subset of first coordinates;
calculating a measure of dependence representative of the dependence of the extracted first values on the extracted second values, wherein the measure of dependence is capable of measuring a non-linear dependence of the extracted first values on the extracted second values.

The neighbourhood may be defined according to user preference.

Calculating a measure of dependence representative of the dependence of the extracted first values on the extracted second values (for each coordinate) may include:
discretizing the extracted first values and the extracted second values;
producing discrete 2D frequency/probability data that represents the frequency/probability at which combinations of discretized first and second values occur (for first and second values having corresponding first and second coordinates) within the extracted first and second values;
calculating a measure of dependence representative of the dependence of the extracted first values on the extracted second values from the discrete 2D frequency/probability data.

The extracted first values and the extracted second values may be discretized independently of one another using an adaptive binning technique, e.g. as taught by Scott [2].

Another binning technique that could potentially be used is the maximal information coefficient, e.g. as taught by Reshef et al [5]. This binning technique can be thought of attempting to maximize mutual information, in other words optimizing the binning by selecting the binning configuration with highest mutual information.

As also shown by FIG. 1 (with a dashed line, because the step is optional), the method of FIG. 1 preferably includes plotting each measure of dependence using the first coordinate for which the measure of dependence was calculated, and/or using the second coordinate corresponding to the first coordinate for which the measure of dependence was calculated.

By plotting the measures of dependence in this way, changes in the seismic attribute within the subsurface region between the first and second times can be detected, e.g. by visual identification.

The inventors believe that difference data plotted in this way provides a more robust visualization of change compared with previous methods.

### Example Workflow 1

Example workflow 1 represents the method of FIG. 1 applied to 4D seismic data, where “Normalized Variation of Information” is used as the measure of dependence.
1. In a defined neighbourhood around each first coordinate, a subset of the first coordinates that lie in the neighbourhood are identified, and the first values that represent the seismic attribute at the subset of first coordinates are extracted.
   a. In this example workflow, the seismic attribute represented by the first and second sets of values is assumed to be amplitude.
      However, in other example workflows, the seismic attribute represented by the first and second sets of values could be, for example, a parameter derived from amplitude, or an alternative seismic attribute, e.g. two way travel time (“TWT”), that may have been pre-calculated.
   b. In this example, the plurality of first and second coordinates are distributed in three dimensions, i.e. such that each value is associated with a 3D coordinate. The neighbourhood size may therefore be defined in 3D by a user. Each value may therefore be associated, for example, with x, y, z coordinates.
   However, in other example workflows, the plurality of first and second coordinates may be distributed in one or two dimensions, in which case the neighbourhood may similarly be defined in 1D or 2D by a user, e.g. with each value being associated with an x coordinate, or x, y coordinates.
2. In this example workflow, extraction of values is done for first and second values, to yield a 2D local histogram representing the dependence of the extracted first values on the extracted second values. This could be represented in plot form by plotting first values against second values (for first and second values having corresponding first and second coordinates)
   a. Note that multiple 2D local histograms are produced as part of the workflow, since a separate 2D local histogram is produced for each first coordinate
   b. Also note that a 2D local histogram can be produced for each first coordinate regardless of whether the first and second coordinates are distributed in one, two or three dimensions.
3. In this example workflow, the extracted first and second values (which in this case represent amplitude) are floating precision and thus quasi continuous. Therefore, in this example workflow, the extracted first and second values are discretized to provide a 2D frequency density function, which is then normalized (to provide a value of 1 when integrated over the function), thereby providing a 2D probability density function that represents (an estimate of) the probability at which combinations of discretized first and second values occur (for first and second values having corresponding first and second coordinates) within the extracted first and second values.
   a. As would be appreciated by a skilled person, a normalized frequency density function (histogram) is essentially the same as a probability density function. Both can be expressed in n-dimensions, though here they are expressed in 2D. A 2D frequency density function can be understood as representing the number of occurrences of a 2D value whereas a 2D probability density function can be understood as representing the probability (or relative frequency) of a 2D value occurring.
   b. For the discretization a variety of methods can be employed. In one preferred implementation the method of Scott is used [2]. Depending on number of samples and standard deviation in the local histogram the binning is preferably adaptively chosen. In his paper [2], Scott shows that this type of binning is optimal under certain assumptions. The discretization is preferably done independently for the two marginal distributions (the distribution of extracted first values and the distribution of extracted second values) in the histogram.
   c. Since the 2D histogram was discretized, the 2D probability density function will also be discrete, with each discrete element of the 2D probability function representing the probability at which a respective pair of discretized first and second values occur at corresponding first and second coordinates within the extracted first and second values
4. From the 2D probability density function the Normalized Variation of Information measure can be directly calculated, e.g. using the equation described in the “theoretical background for workflow 1” section, below.

### Results for Example Workflow 1

In the following some exemplary results are shown for example workflow 1.

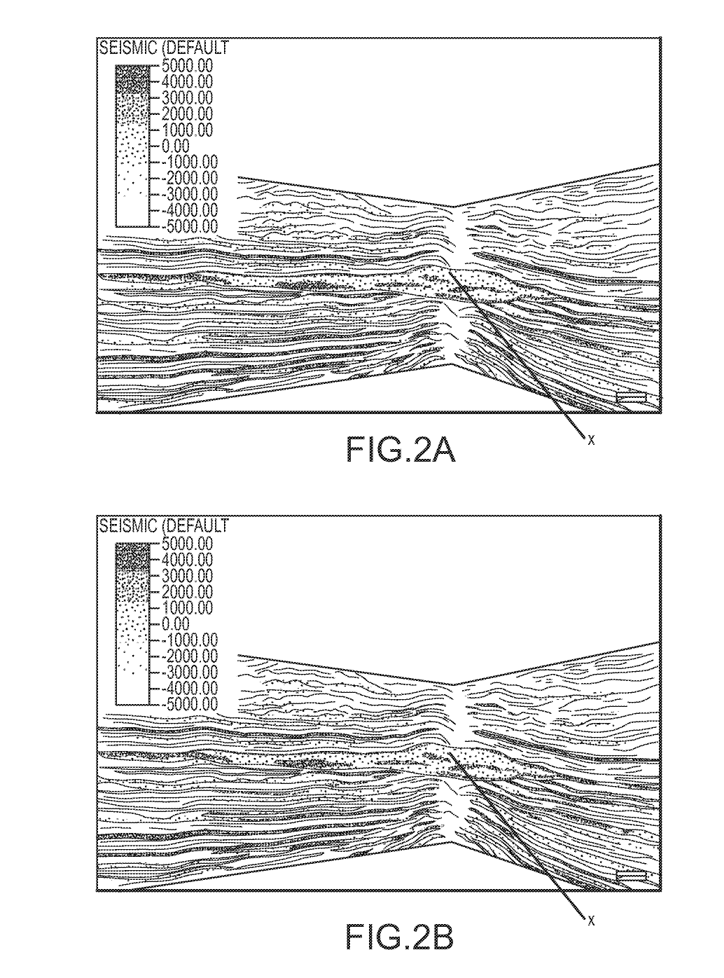

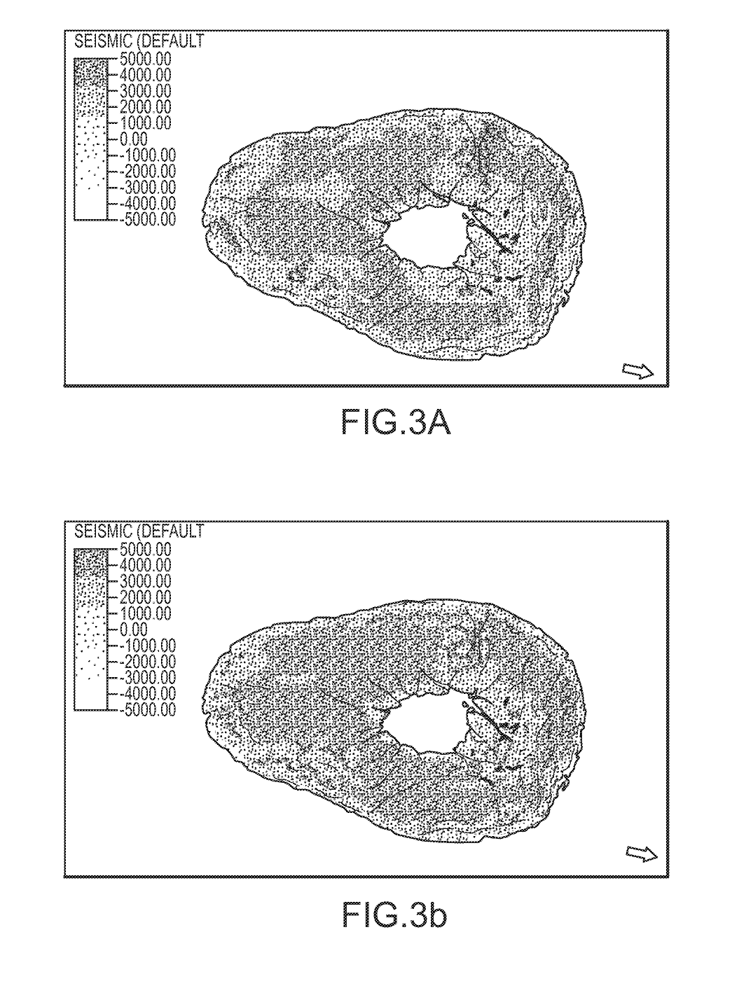

The data used shows a reservoir under production that has been imaged twice in a time span of 12 months. Both the seismic (FIG. 2A and FIG. 2B) and the top surface of the reservoir (FIG. 3A and FIG. 3B) are shown.

The top surface of the subsurface reservoir area in FIG. 2A and FIG. 2B is labelled as ‘X’.

Note that in FIG. 2A and FIG. 2B, the two orthogonal cross sections are shown from a perspective angle, so the point where the two cross sections narrow to a minimum width is where the two cross sections intersect one another.

Note that in FIG. 3A and FIG. 3B, the top surface (which is a 3D surface) is viewed from above, such that the variations in depth of the top surface cannot be seen.

From visual interpretation almost no change is noticeable between the time-lapse seismic data shown in FIG. 2A and FIG. 2B, or in FIG. 3A and FIG. 3B.

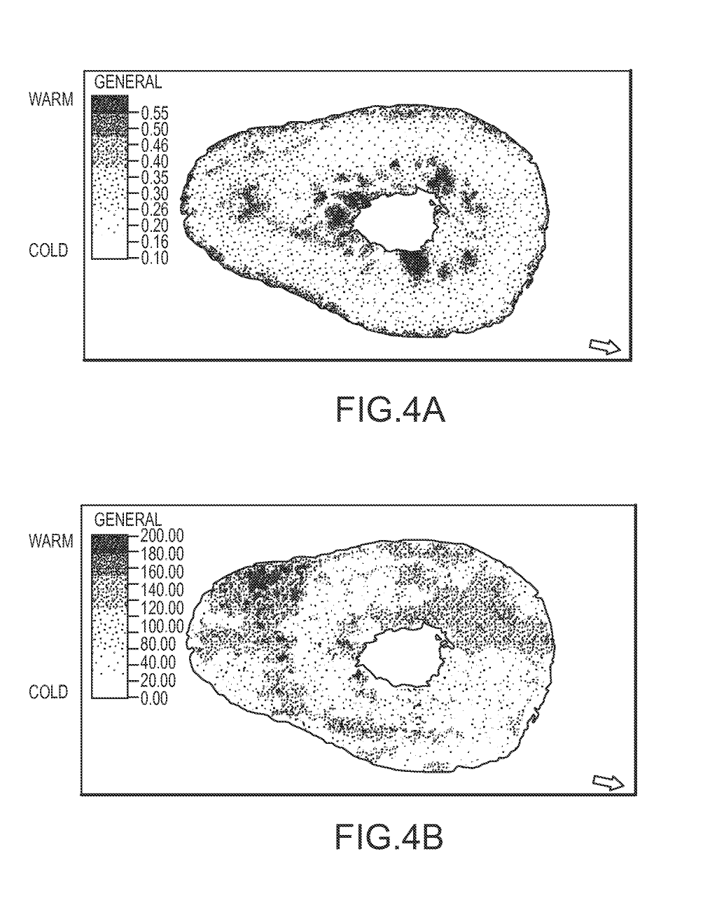

To produce the results shown in FIG. 4A, measures of dependence (in this case Normalized Variation of Information) were calculated in 3D by using example workflow 1 on the time lapse cubes shown in FIG. 2A and FIG. 2B, and then mapped onto the top surface of the reservoir and viewed from above.

FIG. 4B shows the result of using conventional L1 norm to visualize the time cubes shown in FIG. 2A and FIG. 2B, with the L1 norm values being mapped onto the top surface of the reservoir and viewed from above.

In both FIG. 4A and FIG. 4B, “cold” values indicate areas of no change while “warm” colors indicate areas of change.

On review of FIG. 4B, it can be seen that the results are very noisy, making it difficult to identify areas of change.

On review of FIG. 4A, it can be seen that applying the example workflow 1 permits a visualization in which a clear structure is noticeable. It is believed that example workflow 1 therefore provides a more robust representation of change in the 4D seismic data, compared with L1 norm.

### Example Workflow 2

Of course, example workflow 1 is only an example, and other example workflows may be defined using other measures of dependence, and may be applied to different types of data.

This second example workflow is applied to 4D seismic data and uses distance correlation as a measure of dependence.

Step 1 of the workflow is the same as for example workflow 1, with the remaining steps being as follows:
2. In this example workflow, extraction of values is done for first and second values separately to yield two separate local histograms.
   a. Note that many more than two local histograms are produced as a part of the workflow, since two separate local histograms are produced for each first coordinates.
   b. Also note that two local histograms are produced for each first coordinate regardless of whether the first and second coordinates are distributed in one, two or three dimensions.
3. In this example workflow, the two histograms are used to calculate the two distance variances, the distance covariance and the distance correlation using the equations described in the “theoretical background for workflow 2” section, below.
   a. As a side note, no discretization is necessary for distance correlation, so the amplitude values can be taken as they are.

The above description describes a possible method of using a metric for the detection of changes, using information theoretic measures in the context of time-lapse geological objects.

### Further Discussion

In the methods described above, a metric can be used to detect changes in the context of the time-lapse geological objects mentioned above. As input, amplitudes as well as any types of attribute values (including TWT values) can be used. Changes over time can be detected and quantified for every coordinate (“point”). The methods provide data exhibiting a high signal to noise ratio.

The methods described above apply the metric based on discrete values. In order to employ it in the context of seismic, discretization may be performed. In order to get a good estimate, discretization is preferably done adaptively with respect to the underlying local value distribution.

The methods described above may be used to analyse the relationship between different attributes within the cube of data, e.g. by using sets of first and second values that represent different attributes within the cube. In this way, the metric may be employed for the detection of dependencies between two different attributes of the same cube. This is helpful to detect features that are common to both attributes versus features that are not related.

The methods described above may also be used to detect changes between different (e.g. neighbouring) subregions within the same cube of data, e.g. by using sets of first and second values that represent different subregions within the same subsurface region. In this way, the metric could be employed to detect changes between neighbouring regions inside the same cube. Such changes could for example be faults. In this case, inside the same cube, NVI may be calculated between neighbouring subregions that have an offset of a certain length and direction. Calculating the metric for each possible direction separately has the added bonus of discriminating between changes (i.e. faults) that are e.g. in crossline direction versus the ones in inline or other directions.

The methods described above may also be used to detect stratified regions versus non-stratified regions within the same cube of data. Non-stratified regions can be an indication of salt. In this case, the methods may be performed by using a set of first values that represents a “current” subregion within the subsurface region and by using a set of second values that represents another subregion within the subsurface region. The method is then repeated using further subregions as the second set of values. The measure of dependence (e.g. NVI) for each coordinate may then be calculated as an average of the measures of dependence between the current subregion (or “current neighbourhood”) and ALL other subregions (“other neighbourhoods”) in the same cube. Since stratified regions are by far the most common regions in seismic, the method provides, because of the averaging, that stratified regions have a very low NVI value while unstratified salt areas, which are much less common, have a high NVI value.

When used in this specification and claims, the terms “comprises” and “comprising”, “including” and variations thereof mean that the specified features, steps or integers are included. The terms are not to be interpreted to exclude the possibility of other features, steps or integers being present.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

For the avoidance of any doubt, any theoretical explanations provided herein are provided for the purposes of improving the understanding of a reader. The inventors do not wish to be bound by any of these theoretical explanations.

All references referred to above are hereby incorporated by reference.

### Theoretical Background for Example Workflow 1:

Mutual information is based on the concept of entropy in information theory. Entropy H as defined by Shannon [4] quantifies the expected information content I in a sequence of random events. Shannon developed this method in the context of telecommunication. In this context the sequence of random events is usually a message, whereby different events or signs occur with a certain probability.

The entropy describes the expected unorderedness or uncertainty of a random variable. The unit of measurement depends on the base logarithm employed but the most frequently used unit is bits.

### Definition:

H(X)=E[I(X)]=E[−log(P(X))]

Whereby, E denotes the expectation operator, X a discrete random variable and P(X) the probability mass function. In the case of a finite sample this results in:

$$H ( X ) = {\sum }_{i} p ( {x}_{i} ) {log}_{p ( {x}_{i} )}^{1}$$

Accordingly the entropy of a joint distribution (joint entropy) H(X,Y) can be calculated:

$$H ( X , Y ) = {\sum }_{i , j} p ( {x}_{i} , {y}_{j} ) log \frac{1}{p ( {x}_{i} , {y}_{j} )}$$

and the conditional entropy H(X|Y) is given by:

$$H ( X \vert V ) = {\sum }_{i , j} p ( {x}_{i} , {y}_{j} ) log \frac{p ( {y}_{j} )}{p ( {x}_{i} , {y}_{j} )}$$

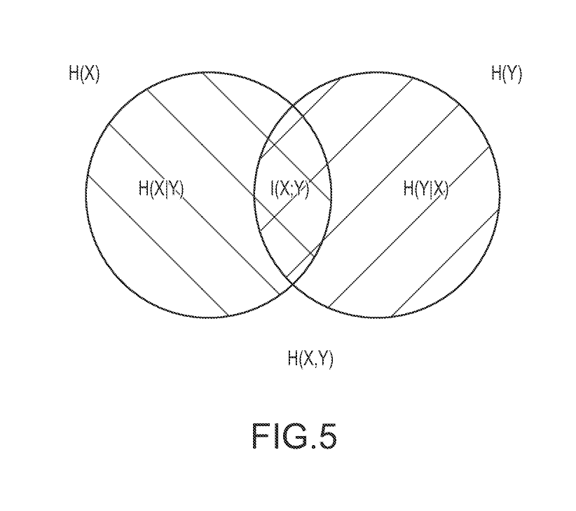

The different measures and their relations for a set of dependent random variables can be visualized in a diagram as shown in FIG. 5.

In this diagram I(X,Y) denotes the mutual information. Mutual information measures the shared information between the two random variables, i.e. the dependence. Mutual information may then for example defined as:

I(X,Y)=H(X)−H(X|Y) or directly as

$$I ( X ; Y ) = {\sum }_{i} p ( {x}_{i} , {y}_{j} ) log ( \frac{p ( {x}_{i} , {y}_{j} )}{p ( {x}_{i} ) p ( {y}_{j} )} )$$

A mutual information value I(X;Y)=0 means that both random variables are completely independent because in the case of independent X and Y: p(x,y)=p(x)p(y) (and log 1=0).

If the variables are normalized, then the mutual information has a maximum value of 1.

Mutual information doesn't satisfy all properties of a metric (in the mathematical sense). However the roughly complementary measure called variation of information does. Variation of information may be defined as follows:

d(X,Y)=H(X,Y)−I(X,Y).

This metric can further be normalized by dividing by H(X,Y) which yields the normalized variation of information metric:

$$D ( X , Y ) = \frac{d ( X , Y )}{H ( X , Y )} \leq 1.$$

In example workflow 1, only the normalized variation of information (NVI) is used even though in practice variation of information and with a few limitations mutual information hold similar or complimentary properties. The results section shows the employment of this measure (NVI) to classify areas of change between two time-lapse cubes.

### Theoretical Background for Example Workflow 2

This section provides some additional detail for distance correlation, also known as “Brownian covariance”.

Distance correlation was first introduce by Gabor J. Szekely in 2007 [6]. It was introduced since the classical Pearson correlation coefficient is only sensitive to linear dependencies and doesn't cover nonlinear relation. As an example if you take the quadratic relation y=x², calculating Pearson's coefficient would yield a result of 0 (uncorrelated), while clearly y and x are dependent. The new distance correlation coefficient covers these cases. The minimum distance correlation value of 0 indicates complete probability independence, while the maximum value of 1 indicates complete linear dependence.

Another very interesting feature of distance correlation is that the variable x and y do not need to be of the same dimension (in a way you are able to compare pears to apples).

The proof and derivation can be found in Szekely's paper [6]. It is based on the characteristic functions (Fourier representations) of the two variables, their Fourier space covariances and a clever definition of a weight function. In the following a rather straight forward calculation of this measure is described.

Given two random variable distribution X and Y (i.e. extracted from baseline cube and time-lapse cube) of size n, for each variable a distance matrix is calculated with the following elements:

a_{j,k}=∥Xⱼ−Xₖ∥, j,k=1,2, . . . , n,

b_{j,k}=∥Yⱼ−Yₖ∥, j,k=1,2, . . . , n,

where ∥ ∥ denotes Euclidean distance.

Both matrices have to be double centered:

A_{j,k}=a_{j,k}−āⱼ−āₖ+ā and B_{j,k}=b_{j,k}−b̅ⱼ−b̅ₖ+b̅

where aⱼ, b̅ⱼ̅ denotes the row mean of the respective matrix; aₖ, b̅ₖ̅ the column mean and
ā, b̅ the global mean.

The squared distance covariance may then be defined as

$$d {Cov}_{n}^{2} ( X , Y ) = \frac{1}{{n}^{2}} {\sum }_{j , k}^{n} {A}_{j , k} {B}_{j , k}$$

The distance variance may be defined as the distance covariance of two identical variables

dVarₙ²(X)=dCovₙ²(X,X),

Distance correlation may then be defined as:

$$d {Cor}_{n} ( X , Y ) = \frac{d {Cov}_{n} ( X , Y )}{\sqrt{d {Var}_{n} ( X ) d {Var}_{n} ( Y )}}$$

### BIBLIOGRAPHY

[1] “Seismic repeatability, normalized rms, and predictability”, Ed Kragh, Phil Christie, The Leading Edge (July 2002), Vol. 21, No. 7, pp. 640-647
[2] “On optimal and data-based histograms”, Scott, D. W., Biometrika (1979), pp. 605-610.
[3] “Atlas of 3D seismic attributes”, Trygve Randen, Lars Sonneland, Mathematical Methods and Modelling in Hydrocarbon Exploration and Production, Mathematics in Industry Volume 7 (2005), pp. 23-46.
[4] “A mathematical theory of communication”, C. E. Shannon, The Bell System Technical Journal, Vol 27 (July, October 1948), pp. 379-423, 623-656. (Note: Shannon's term “rate of transmission” in this paper is equivalent to “Mutual Information”)
[5] “Detecting Novel Associations in Large Data Sets”, Reshef et al., Science Vol. 334 (16 Dec. 2011), pp. 1518-1524.
[6] “Measuring and testing dependence by correlation of distances”, Székely, Gábor J., Rizzo, Maria L., Bakirov, Nail K., The Annals of Statistics vol 35 (2007), no. 6, pp. 2769-2794.

1. A method of analysing a subsurface region, the method comprising:
obtaining a set of first values representing a first attribute at a plurality of first coordinates within the subsurface region;
obtaining a set of second values representing a second attribute at a plurality of second coordinates within the subsurface region, wherein each of the plurality of second coordinates corresponds to a respective first coordinate;
for each first coordinate, calculating a measure of dependence by:
identifying a subset of the first coordinates that lie in a neighbourhood around the first coordinate;
extracting, from the set of first values, the first values that represent the first attribute at the subset of the first coordinates;
extracting, from the set of second values, the second values that represent the second attribute at a subset of the second coordinates, wherein the second coordinates in the subset of the second coordinates correspond to the first coordinates in the subset of first coordinates; and
calculating a measure of dependence representative of the dependence of the extracted first values on the extracted second values, wherein the measure of dependence is configured for measuring a non-linear dependence of the extracted first values on the extracted second values.

2. A method according to claim 1, wherein the measure of dependence is variation of information, mutual information or distance correlation.

3. A method according to claim 1, wherein the measure of dependence is normalized.

4. A method according to claim 1, wherein each second coordinate is substantially the same as a respective first coordinate.

5. A method according to claim 1, wherein the method includes plotting each measure of dependence using the first coordinate for which the measure of dependence was calculated, and/or using the second coordinate corresponding to the first coordinate for which the measure of dependence was calculated.

6. A method according to claim 1, wherein calculating a measure of dependence representative of the dependence of the extracted first values on the extracted second values includes:
producing 2D frequency/probability data that represents the frequency/probability at which combinations of first and second values occur within the extracted first and second values; and
calculating a measure of dependence representative of the dependence of the extracted first values on the extracted second values from the 2D frequency/probability data.

7. A method according to claim 1, wherein calculating a measure of dependence representative of the dependence of the extracted first values on the extracted second values includes:
discretizing the extracted first values and the extracted second values;
producing discrete 2D frequency/probability data that represents the frequency/probability at which combinations of discretized first and second values occur within the extracted first and second values; and
calculating a measure of dependence representative of the dependence of the extracted first values on the extracted second values from the discrete 2D frequency/probability data.

8. A method according to any previous claim, wherein:
the first values represent a first attribute at the plurality of first coordinates within the subsurface region at a first time;
the second values represent the second attribute at the plurality of second coordinates within the subsurface region at a second time;
the first attribute is the same as the second attribute; and
the first time is different to the second time.

9. A method according to claim 1, wherein the first attribute is different from the second attribute.

10. A method according to claim 1, wherein:
the set of first values represent a first seismic attribute at a plurality of coordinates within the subsurface region; and
the set of second values represent a second seismic attribute at a plurality of coordinates within the subsurface region.

11. A method according to claim 1, wherein the plurality of first coordinates and the plurality of second coordinates are distributed in three spatial dimensions.

12. A method according to claim 1, wherein the subsurface region is a subsurface reservoir.

13. A computer-readable medium having computer-executable instructions configured to cause a computer to perform a method according to claim 1.

14. A method according to claim 1, further comprising:
using the calculated measure of dependence to analyse the subsurface region.

15. A method according to claim 14, wherein analysing the subsurface region comprises identifying a subsurface reservoir.

16. A method of analysing a subsurface region, the method comprising:
receiving 4D seismic data from a subterranean reservoir;
obtaining from the 4D seismic data a set of first values representing a first attribute at a plurality of first coordinates within the subsurface region;
obtaining from the 4D seismic data a set of second values representing a second attribute at a plurality of second coordinates within the subsurface region, wherein each of the plurality of second coordinates corresponds to a respective first coordinate; and
for each first coordinate, calculating a measure of dependence by:
identifying a subset of the first coordinates that lie in a neighbourhood around the first coordinate;
extracting, from the set of first values, the first values that represent the first attribute at the subset of the first coordinates;
extracting, from the set of second values, the second values that represent the second attribute at a subset of the second coordinates, wherein the second coordinates in the subset of the second coordinates correspond to the first coordinates in the subset of first coordinates; and
calculating a measure of dependence representative of the dependence of the extracted first values on the extracted second values, wherein the measure of dependence is configured for measuring a non-linear dependence of the extracted first values on the extracted second values; and
using the calculated measure of dependence to detect changes in the reservoir over time.

17. A method according to claim 16, wherein the detected changes in the reservoir over time comprises classifying top and base surfaces of the reservoir.

18. A method according to claim 16, wherein the detected changes in the reservoir over time comprises identifying change versus non-change neighborhoods in the reservoir.

19. A method according to claim 16, wherein the 4D seismic data is recorded objective while fluids are being injected into the reservoir and/or hydrocarbons are being produced from the reservoir.

20. A method according to claim 16, wherein the calculated measure of dependence comprises a probability dependence of the first and the second set of values.

21. A method according to claim 16, wherein the detected changes in the reservoir over time are used to extract faults and/or salt bodies from the 4D seismic data.
